(19) United States
(12) Patent Application Publication
(10) Pub. No.: US 2021/0227862 A1
(43) Pub. Date: Jul. 29, 2021

(54) PROCESS FLAVOUR

(71) Applicant: DSM IP ASSETS B.V., Heerlen (NL)

(72) Inventors: Marco Alexander VAN DEN BERG, Echt (NL); Frank Richard MEIJER, Echt (NL)

(21) Appl. No.: 17/058,852

(22) PCT Filed: May 21, 2019
(86) PCT No.: PCT/EP2019/063064

§ 371 Date: Nov. 25, 2020

(30) Foreign Application Priority Data
May 28, 2018 (EP) 18174537.3
May 28, 2018 (EP) 18174538.1

(51) Int. Cl. A23L 27/10; A23L 33/125; A23L 33/16; A23L 27/00; A23P 30/20

(52) U.S. Cl. CPC A23L 27/10; A23L 33/125; A23P 30/20; A23L 27/88; A23L 33/16

(57) ABSTRACT

The present invention relates to a method for producing a process flavour comprising: a) preparing a composition comprising a vegetable and a processing aid chosen from sucrose, NaCl and KCl or combinations thereof, b) intimately mixing the composition in an extruder under conditions of temperature and reaction time sufficient for the process flavour to develop, wherein the composition does not comprise yeast, yeast extract or yeast autolysate wherein the amount of vegetable is within the range of 50 to 98% (w/w) of the composition, wherein the water content of the composition before or during step b) is between 1% and 8% w/w based on the total weight of the composition.

The present invention relates to a method for producing a process flavour. Further, the present invention relates to a process flavour. Still further, the present invention relates to the use of the process flavour.

### BACKGROUND

Process flavours are widely used in the food industry to provide flavour to food products or to enhance certain flavours of a food product. Process flavours can be prepared by extruding ingredients under heating conditions to induce browning reactions, for a time period sufficient to develop the desired flavour profile. The advantage of the extrusion process is that the flavour compounds are encapsulated in the extrudate, or so-called melt, which protects the flavour compounds from oxidation.

Yeast is a commonly used ingredient in the extrusion of process flavours because it imparts an umami flavour profile to the process flavour and the proteins of the yeasts could function as an appropriate melt to encapsulate the flavour compounds. However, a current trend in the food industry is to provide food products comprising only cupboard ingredients which are known to the consumer.

Therefore, there is a need in the art to provide process flavours which are based on ingredients which are recognizable by the consumer. Given the complex flavour formation reactions in extrusion processes, it is a challenge to identify ingredients fulfilling the consumer needs and still providing a desired process flavour.

Vegetables are a promising recognizable source for the production of process flavours. However, in the absence of yeast extract the problem occurs that the browning reaction between the vegetables is uncontrollable. This results in process flavours having an overreacted colour, resulting in an undesired flavour profile. Hence, there is a need in the art to produce vegetable based process flavours in a controllable manner. Further, there is a need in the art for vegetable based process flavours, having a desired degree of browning. Further, there is a need for vegetable based process flavours having a balanced flavour profile, for example not to high in roast, in cooked, in clear vegetable notes etc.

This problem, amongst other problems, is solved by the present invention.

### SUMMARY

According to a first aspect, the present invention relates to a method for producing a process flavour comprising:
a) preparing a composition comprising a vegetable and a processing aid chosen from sucrose, NaCl and KCl or combinations thereof,
b) intimately mixing the composition in an extruder under conditions of temperature and reaction time sufficient for the process flavour to develop,

wherein the composition does not comprise yeast, yeast extract or yeast autolysate

wherein the amount of vegetable is within the range of 50 to 98% (w/w) of the composition and/or

wherein the water content of the composition before or during step b) is between 1% and 8% w/w based on the total weight of the composition.

In a preferred embodiment, the present amount of processing aid is within the range of 0.01 to 40% (w/w) of the composition.

In a preferred embodiment, the present composition comprises sucrose and NaCl, preferably in an amount within the range of 0.01 to 40% (w/w) of the composition.

In a preferred embodiment, the present composition further comprises maltodextrin and/or sunflower oil.

In a preferred embodiment, the present vegetable is in the form of a powder.

In a preferred embodiment, the present vegetable is chosen from the group consisting of soy, onion, garlic, cabbage, carrot, celery, mushroom, tomato, bell pepper, leek, scallion, shallot, corn, rice, cauliflower, asparagus and broccoli.

In a preferred embodiment, the present amount of vegetable is within the range of 60 to 98% (w/w) of the composition.

In a preferred embodiment, the present temperature of step b) is between 100° C. and 160° C.

In a preferred embodiment, the present reaction time is within the range of 3 seconds to 6 minutes.

According to another aspect, the present invention relates to a process flavour. Preferably, the present invention relates to a process flavour obtainable by the present method.

Preferably, the present invention relates to a process flavour comprising vegetable and sucrose and/or salt, wherein the vegetable and sucrose and/or salt are homogenously distributed in the process flavour.

In a preferred embodiment, the present process flavour has a colour value within the range of 0.01 to 3.2 measured at 400 nm and at a light pathlength of 12.5 mm if dosed at 1 gram in 100 ml hot cooked water.

In a preferred embodiment, the present process flavour has a L value of larger than 55 on a Hunter LAB colour scale.

In a preferred embodiment, the present process flavour has an amount of vegetable within the range of 50 to 98% (w/w) of the process flavour.

In a preferred embodiment, the present process flavour is an extruded powder or granulate.

According to another aspect, the present invention relates to the use of the present process flavour in preparing food.

### DETAILED DESCRIPTION

According to a first aspect, the present invention relates to a method for producing a process flavour comprising:
a) preparing a composition comprising a vegetable and a processing aid chosen from sucrose, NaCl and KCl or combinations thereof, preferably chosen from sucrose and/or NaCl,
b) intimately mixing the composition in an extruder under conditions of temperature and reaction time sufficient for the process flavour to develop,

wherein the composition does not comprise yeast, yeast extract or yeast autolysate

wherein the amount of vegetable is within the range of 50 to 98% (w/w) of the composition and/or

wherein the water content of the composition before or during step b) is between 1% and 8% w/w based on the total weight of the composition.

The present inventors found that the addition of sucrose and/or NaCl in the composition provides a process flavour which is lighter in colour. Lighter in colour means that the process flavour is not overreacted and thus the browning reaction to develop the process flavour is controlled. Hence, the present invention provides a method to produce vegetable based process flavours in a controllable manner. Preferably, the present step b) provides the present process flavour in a controllable manner. Preferably, the present step b) is carried out without overreaction or without excessive browning of the process flavour. More preferably, the present process flavour does not have a roast flavour profile. Most preferably, the present process flavour has a lighter colour if compared with a similar process flavour produced under similar conditions without the presence of sucrose and/or NaCl in the composition.

In the context of the invention the “intimately mixing” may include any form of mixing. It includes stirring, kneading and pressing. The intimate mixing is preferably done at a pressure above atmospheric pressure. The extruder is preferably suitable for stirring, kneading and pressing the present composition. The extruder may be any type of extruder suitable for the production of process flavours, such as a twin-screw extruder. Extruders, e.g. twin-screw extruders, are known in the art. The extruder may have any volume, the volume being the maximum volume inside the extruder which may be taken by the composition. Preferably the volume is between 1 gram and 1000 kg. More preferably the volume is between 5 grams and 100 kg, more preferably between 10 grams and 10 kg. The composition of step a) and optionally water and/or oil may be introduced into the extruder through the same or separate feeders.

In a preferred embodiment, the present composition does not comprise free amino acids, or added amino acids or exogenous amino acids. More preferably, the present composition does not comprise added nucleotides or ribonucleotides or exogenous nucleotides or exogenous ribonucleotides. Most preferably, the present composition does not comprise sodium glutamate or exogenous sodium glutamate or added sodium glutamate. The term exogenous is used to define that the compound is not endogenous to the present vegetable.

In a preferred embodiment, the present amount of processing aid is within the range of 0.01 to 40% (w/w) of the composition. Surprisingly, the present inventors found that the addition of sucrose and/or NaCl controls the degree of browning reaction, while the resulting process flavour is not perceived as sweet or salt if compared with a process flavour without the addition of sucrose and/or NaCl. This is advantageous because too sweet or too salty flavour profiles are undesired and limit the range of applications wherein the process flavour can be used. Preferably, the present amount of processing aid is within the range of 0.1 to 35% (w/w), preferably, 0.5 to 30% (w/w), more preferably 1 to 25% (w/w), even more preferably within the range of 2 to 20% (w/w), most preferably within the range of 5 to 15% (w/w).

In a preferred embodiment, the present composition or processing aid comprises sucrose and NaCl, preferably in a combined amount within the range of 0.01 to 40% (w/w) of the composition. More preferably, the amount of sucrose and NaCl is combined within the range of 0.1 to 35% (w/w), more preferably within the range of 0.5 to 30% (w/w), even more preferably within the range of 1 to 25% (w/w), most preferably within the range of 5 to 15% (w/w) of the composition. More preferably, the amount of sucrose is within the range of 0.1 to 35% (w/w), more preferably within the range of 1 to 30% (w/w), even more preferably within the range of 2 to 25% (w/w), most preferably within the range of 5 to 15% (w/w) of the composition. More preferably, the amount of NaCl is within the range of 0.1 to 35% (w/w), more preferably within the range of 0.5 to 30% (w/w), even more preferably within the range of 1 to 25% (w/w), most preferably within the range of 5 to 15% (w/w) of the composition.

In a preferred embodiment, the present composition further comprises, maltodextrin and/or an oil. The present inventors found that maltodextrin or sunflower oil are not able to control the browning reaction. However, what is surprising is that the addition of maltodextrin and/or sunflower oil to the composition in the presence of sucrose further improve the controllability of the browning reaction. The amount of maltodextrin is preferably within the range of 1 to 25% (w/w), more preferably within the range of 5 to 20% (w/w), even more preferably within the range of 8 to 18% (w/w), most preferably within the range of 10 to 15% (w/w) of the composition.

The oil of the composition may be any edible oil. Within the context of the invention “oil” is defined as an ester of glycerol and at least one fatty acid. The oil may be either solid or liquid at normal room temperature. Oil is understood to include fat and lipid. The term oil is generally used for fatty acid glycerol esters that are liquid at normal room temperature, whereas the term fat is used to refer to fatty acid glycerol esters that are solid at normal room temperature. The oil may be a mono-, di-, and/or triglyceride. Combinations of mono-, di- and/or triglycerides also fall under the scope of the invention. In a preferred embodiment the oil is sesame oil. The oil may advantageously smoothen the process such that the process is more stable. Preferably the oil is sunflower oil. More preferably the oil is high oleic sunflower oil. High oleic sunflower oil is defined as a sunflower oil having at least 80% (w/w) of oleic acid. The amount of oil is preferably within the range of 0.1 to 10% (w/w), more preferably within the range of 0.5 to 5% (w/w), even more preferably within the range of 1 to 4% (w/w), most preferably within the range of 1.5 to 3% (w/w) of the composition.

The present composition does not comprise yeast, yeast extract or yeast autolysate. The Food Chemical Codex defines a “yeast extract” as follows: “Yeast Extract comprises the water soluble components of the yeast cell, the composition of which is primarily amino-acids, peptides, carbohydrates and salts. Yeast extract is produced through the hydrolysis of peptide bonds by the naturally occurring enzymes present in edible yeast or by the addition of food-grade enzymes”. The Food Chemical Codex defines “autolysed yeast” as “the concentrated, nonextracted, partially soluble digest obtained from food-grade yeast. Solubilization is accomplished by enzyme hydrolysis or autolysis of yeast cells. Food-grade salts and enzymes may be added. Yeast, autolyzed, contains both soluble and insoluble components derived from the whole yeast cell. It is composed primarily of amino acids, peptides, carbohydrates, fats, and salts”.

Vegetables, as used herein, are defined as the flower, fruits, stems, leaves, roots, tubers, bark, seeds and all other plant material, including consumable parts of fungi (like mushroom) consumed as a nutrient. This definition of vegetables excludes herbs and spices which are not nutrients. Herbs and spices are defined as organic material used for garnishing of food, excluding vegetables consumed as nutrient. Preferably, the present the vegetable is chosen from the group consisting of soy, onion, garlic, cabbage, carrot, celery, mushroom, tomato, bell pepper, leek, scallion, shallot, corn, rice, cauliflower, asparagus and broccoli, more preferably chosen from the group consisting of soy, onion, garlic, cabbage, carrot, celery, mushroom, tomato, bell pepper, leek, scallion, shallot, chives, corn, rice, wheat, ginger, cauliflower, asparagus and broccoli. More preferably, the present vegetable is one or more chosen from onion, garlic, mushroom and tomato.

In a preferred embodiment, the amount of herb and spices within the present composition is within the range of 0 to 10% (wt) of the composition. More preferably, the amount of herb and spices within the present composition is within the range of 0.5 to 8% (wt) of the composition. Even more preferably, the amount of herb and spices within the present composition is within the range of 1 to 6% (wt) of the composition, such as within the range of 1.5 to 5% (wt) of the composition.

The vegetable is preferably a dry vegetable. Within the context of the invention “dry” is defined as having a water content of less than 15% w/w, more preferably less than 12% w/w, 10% w/w, even more preferably less than 8% w/w based on the total weight of the vegetable. A dry vegetable may result in a vegetable flavour with a more concentrated flavour. The vegetable may be dried, for example a vegetable which is dried in an oven or in the sun. In an embodiment the vegetable of the composition of the process of the invention is a vegetable flavour.

In an embodiment, the vegetable is a chopped vegetable. Within the context of the invention “chopping” includes any physical method causing the vegetable to break apart in a plurality of particles which are smaller than the vegetable itself. Chopped vegetables are understood to include milled, extruded, ground, shredded, rolled, cut, and mashed vegetables. The chopped vegetable particles thus formed may be in the form of a powder, granules, flakes, or pellets. Chopped vegetables have a higher surface/content ratio than the intact vegetable. It is believed that a high surface/content ratio of the vegetable may be important in the process of the invention since it allows for intimate mixing in step b). Therefore, the vegetable is preferably in the form of a powder. Even more preferably the vegetable powder is a vegetable juice powder. A juice power is obtained by extracting the liquid from a vegetable, for example by pressing, and drying said liquid fraction to obtain a powder. A vegetable juice powder is different from a vegetable powder in that the former has less or no fibers. The absence of fibers in a vegetable juice powder may make it suitable to make an even more concentrated vegetable flavour as compared to using a vegetable powder. Moreover, the absence of fibers may be advantageous to be used in the process of the invention. For example, when using extrusion the absence of fibers may prevent clogging and may result in a higher production rate of the concentrated vegetable flavour (e.g. in kg/h).

In a preferred embodiment, the present amount of vegetable is within the range of 50 to 97% (w/w) of the composition. More preferably, the amount of vegetable is within the range of 55 to 95% (w/w), more preferably within the range of 60 to 90% (w/w), more preferably within the range of 62 to 85% (w/w), more preferably within the range of 65 to 80% (w/w), even more preferably within the range of 67 to 75% (w/w), most preferably within the range of 60 to 70% (w/w) of the composition.

The water content of the present composition before or during step b) is between 1% and 8% w/w based on the total weight of the composition. The water content of the composition before or during step b) of the process according to the invention is preferably between 1% and 8% w/w based on the total weight of the composition. The water content of the composition before or during step b) of the process of the invention may be important for obtaining the desired flavour, particularly the desired concentration of the flavour. When the water content of the composition is too high, e.g. more than 8%, the concentration of the vegetable flavour may be too low, or the throughput in the extruder may slow down or stop. When the water content is too low, e.g. less than 1%, burnt off notes may occur. Advantageously, the use of the processing aid allows to extrude a composition with a low amount of water, and thus the provision of concentrated flavours, without negative side effects like overreaction.

In a preferred embodiment, the developed process flavour has a L value of larger than 55 on a Hunter LAB colour scale, preferably wherein the L value is measured according to the following test:

using a Hunterlab Ultrascan VIS Spectrocolorimeter, having a Micro port plate 9.525 mm with cuvette holder with a reflective shelf assembly with cover; using the following steps at ambient temperature:
unscrew the cup of the cuvette holder;
fill the cup with 200-300 mg of the process flavour and screw the cup back on the cuvette holder;
optionally, place a teflon rod into the cup and compress the powder firmly with it;
   place the cuvette holder in the sample holder and measure the colour. More preferably, the developed process flavour has a L value within the range of 55 to 100. More preferably the developed process flavour has a L value within the range of 55 to 90, 55 to 80, 55 to 70, 55 to 65, or 55 to 60.

In a preferred embodiment, the present temperature of step b) is between 100° C. and 160° C. Preferably, the temperature is between 110 and 150° C., more preferably between 120 and 145° C., most preferably between 125 and 140° C. When the incubation temperature is too low, e.g. below 100° C., the vegetable flavour produced may not be concentrated. When the incubation temperature is too high (e.g. >160° C.), the vegetable flavour produced may have burnt off notes.

In a preferred embodiment, the present reaction time is within the range of 3 seconds to 6 minutes. More preferably, the reaction time is within the range of 10 seconds to 5 minutes, most preferably within the range of 30 seconds to 3 minutes. The skilled person will understand that the incubation time in step b) of the process of the invention depends on the incubation temperature as well as on the water content of the composition during or before step b) and on the desired process flavour. At higher incubation temperatures the incubation time may be shorter in order to obtain the desired concentrated vegetable flavour, whereas at lower incubation temperatures the incubation time may be longer in order to obtain the desired concentrated vegetable flavour. Likewise, at lower water contents the incubation time may be shorter, whereas at higher water contents the incubation time may be longer. The skilled person may therefore, without undue burden, establish suitable conditions with respect to temperature, time and water content in order to obtain the desired concentrated vegetable flavour.

The present process flavour can have a wide variety of flavour profiles, since different vegetables, or combination of vegetables give different flavour profiles, which are not limited to vegetable flavour profiles. Hence, by using the invention, vegetables can advantageously be used to provide process flavours which have clean label due to the natural ingredients.

Given the beneficial process flavour provided by the present method, the present invention relates, according to another aspect, to a process flavour. Preferably, the present invention relates to a process flavour obtainable by the present method. In a preferred embodiment, the present process flavour is an extruded powder or granulate.

The process flavour obtainable by the process of the invention may advantageously be stable, for example during storage. With stable is meant that the concentration of the process flavour obtainable by the process of the invention is stable over time, i.e. that the amount of the process flavour obtainable by the process of the invention to be added to a food in order to provide a flavour does not increase over time. Preferably the process flavour obtainable by the process of the invention is stable for at least 1 month, more preferably for at least 2 months, 3 months, more preferably at least 6 months, most preferably at least 12 months, where the process flavour obtainable by the process of the invention is stored between 20 and 25° C. in the dark.

Preferably, the present invention relates to a process flavour comprising vegetable and a processing aid chosen from sucrose, NaCl and KCl, preferably, wherein the vegetable and processing aid chosen from sucrose NaCl, and KCl are homogenously distributed in the process flavour. Homogenously distributed means that the vegetable and processing aid are thoroughly mixed and equally distributed among the process flavour. More preferably, the present vegetable and processing aid are equally distributed in the extruded melt of the present process flavour. Preferably, the processing aid is sucrose, is NaCl, or is a combination of sucrose and NaCl.

The vegetable herein is defined as above. The amount of vegetable is within the range of 50 to 98% (w/w) of the process flavour. More preferably, the amount of vegetable is within the range of 55 to 95% (w/w), more preferably within the range of 60 to 90% (w/w), more preferably within the range of 62 to 85% (w/w), more preferably within the range of 65 to 80% (w/w), even more preferably within the range of 67 to 75% (w/w), most preferably within the range of 60 to 70% (w/w) of the process flavour.

Preferably, the amount of processing aid is within the range of 0.01 to 40% (w/w) of the process flavour. Surprisingly, the present inventors found that the addition of sucrose and/or NaCl controls the degree of browning reaction, while the resulting process flavour is not perceived as sweet or salt if compared with a process flavour without the addition of sucrose or NaCl. This is important because too sweet or too salt flavour profiles are undesired and limit the range of applications wherein the process flavour can be used.

In a preferred embodiment, the present process flavour comprises sucrose and NaCl, preferably in a combined amount within the range of 0.01 to 40% (w/w) of the process flavour. More preferably, the amount of sucrose and NaCl is combined within the range of 0.1 to 35% (w/w), more preferably within the range of 0.5 to 30% (w/w), even more preferably within the range of 1 to 25% (w/w), most preferably within the range of 5 to 15% (w/w) of the process flavour. More preferably, the amount of sucrose is within the range of 0.1 to 35% (w/w), more preferably within the range of 1 to 30% (w/w), even more preferably within the range of 2 to 25% (w/w), most preferably within the range of 5 to 15% (w/w) of the process flavour. More preferably, the amount of NaCl is within the range of 0.1 to 35% (w/w), more preferably within the range of 0.5 to 30% (w/w), even more preferably within the range of 1 to 25% (w/w), most preferably within the range of 5 to 15% (w/w) of the process flavour.

In a preferred embodiment, the amount of herb and spices within the present process flavour is within the range of 0 to 10% (wt) of the process flavour. More preferably, the amount of herb and spices within the present composition is within the range of 0.5 to 8% (wt) of the process flavour. Even more preferably, the amount of herb and spices within the present process flavour is within the range of 1 to 6% (wt) of the process flavour, such as within the range of 1.5 to 5% (wt) of the process flavour.

In a preferred embodiment, the present process flavour has a colour value within the range of 0.01 to 3.2 measured at 400 nm and at a light pathlength of 12.5 mm if dosed at 1 gram in 100 ml hot cooked water. More preferably the present process flavour has a colour value within the range of 0.1 to 2.5, more preferably within the range of 0.5 to 2.0. most preferably within the range of 0.5 to 1.0, if measured at 400 nm and at a light pathlength of 12.5 mm if dosed at 1 gram process flavour in 100 ml hot cooked water. Preferably, hot cooked water is water with a temperature of more than 97° C., preferably more than 98° C., more preferably more than 99° C., most preferably of 100° C.

In a preferred embodiment, the present colour value is measured according to the following test: 1.00 gram of the process flavour is weighted into a 250 ml plastic cup, and subsequently 100 ml of hot cooking water is added; the solutions is stirred twice for 10 seconds to homogenize; with a syringe 5 ml of the solution is taken and filtrated over a Acrodisc 13 mm syringe filter with a 0.45 μm nylon membrane and the filtrate is measured in a disposable cuvette with dimension 12.5×12.5×45 mm; the process flavour is measured at 400 nm and at a light pathlength of 12.5 mm, wherein water is used as reference.

In a preferred embodiment, the present process flavour has a L value of larger than 55 on a Hunter LAB colour scale. Preferably, the present process flavour has a L value within the range of 55 to 100. More preferably the present process flavour has a L value within the range of 55 to 90, 55 to 80, 55 to 70, 55 to 65, or 55 to 60.

More preferably, the present L value is measured according to the following test: using a Hunterlab Ultrascan VIS Spectrocolorimeter, having a Micro port plate 9.525 mm with cuvette holder with a reflective shelf assembly with cover; using the following steps at ambient temperature:
unscrew the cup of the cuvette holder;
fill the cup with 200-300 mg of the process flavour and screw the cup back on the cuvette holder;
optionally, place a teflon rod into the cup and compress the powder firmly with it;
place the cuvette holder in the sample holder and measure the colour.
   In a preferred embodiment, the present process flavour does not comprise yeast, yeast extract or yeast autolysate, as defined herein. In a preferred embodiment, the present process flavor does not comprise free amino acids, or added amino acids or exogenous amino acids. More preferably, the present process flavor does not comprise added nucleotides or ribonucleotides or exogenous nucleotides or exogenous ribonucleotides. Most preferably, the present process flavor does not comprise sodium glutamate or exogenous sodium glutamate or added sodium glutamate. The term exogenous is used to define that the compound is not endogenous to the present vegetable.

According to another aspect, the present invention relates to the use of the present process flavour in preparing food. More preferably, the amount of the present process flavour in a food item is within the range of 0.01 to 5% (w/w), more preferably 0.1 to 4% (w/w), most preferably within the range of 0.1 to 3% (w/w) of the food item.

The invention is further illustrated in the examples below.

### EXAMPLES

### Materials

Carrot juice powder (Alcarn5004) was obtained from Diana Naturals, Antrain (France)
Onion Juice Powder (Aloign5003) was obtained from Diana Naturals, Antrain (France)
Grounded celery leaves (7006120) were obtained from Intertaste (The Netherlands)
Leek extract powder (Alpore410622) was obtained from Diana Naturals, Antrain (France)
Turmeric powder (HL1093) was obtained from Natural Spices (The Netherlands)
Revel vegetable fat powder (1639645) was obtained from 101 Loders Crocklaan (The Netherlands)
Food grade pure dried vacuum salt; V extra fine (50287) was obtained from ESCO (Germany)
Sucrose, extra fine was obtained from Suiker Unie (The Netherlands)
Hozol (High Oleic Sunflower Oil, kosher) (1000359), was obtained from Cargill (Belgium)
Maltodextrin IT12 P was obtained from Roquette (France)

### Example 1

### Production Process Flavours Using Sucrose

To a lab scale twin-screw extruder, (equipped with a dosing unit), compositions according to samples 1 to 5 of table 1 were added and extruded with a throughput time of 2 minutes. The extruder was set at a temperature of 140° C., resulting in an incubation temperature of around 140° C. The products formed left the extruder in a room under atmospheric pressure and were cooled, and subsequently grinded and sampled.

TABLE 1

| | Sample | Sample | Sample | Sample | Sample |
|---|---|---|---|---|---|
| Component | 1 | 2 | 3 | 4 | 5 |
| Carrot, juice powder | 50.60 | 47.76 | 49.13 | 43.18 | 36.66 |
| Onion, powder | 32.42 | 30.60 | 31.48 | 27.67 | 23.49 |
| Celery leaves, grounded | 5.01 | 4.73 | 4.86 | 4.28 | 3.63 |
| Leek powder | 9.16 | 8.65 | 8.90 | 7.82 | 6.64 |
| Turmeric powder | 0.50 | 0.47 | 0.48 | 0.42 | 0.36 |
| Fat powder | 2.31 | 2.18 | 2.24 | 1.97 | 1.67 |
| Sucrose | 0.00 | 5.61 | 0.00 | 0.00 | 8.62 |
| HOZOL | 0.00 | 0.00 | 2.91 | 0.00 | 4.31 |
| Maltodextrin IT12 P | 0.00 | 0.00 | 0.00 | 14.66 | 2.17 |
| NaCl | 0.00 | 0.00 | 0.00 | 0.00 | 12.45 |

### Colour Measurement

1.00 gram of the samples 1 to 5 were weighted into a 250 ml plastic cup, and subsequently 100 ml of hot cooking water was added. The solutions were stirred twice for 10 seconds to homogenize. With a syringe 5 ml of the solutions was taken and filtrated over an Acrodisc 13 mm syringe filter with a 0.45 μm nylon membrane and the filtrate was measured in a disposable cuvette with dimension 12.5×12.5×45 mm. The sample was measured at 400 nm and at a light pathlength of 12.5 mm, wherein water is used as reference. The colour value is shown in table 2.

TABLE 2

| Sample | # 1 | # 2 | # 3 | # 4 | # 5 |
|---|---|---|---|---|---|
| Colour value | 0.917 | 0.830 | 0.958 | 1.077 | 0.525 |

### Sensory Analysis

0.30 gram of the samples 1 to 5 were weighted into a 250 ml plastic cup, and subsequently 100 ml of hot cooking water was added. The solutions were stirred twice for 10 seconds to homogenize. The solutions were divided in tasting cups of 10 to 15 ml and a tasting panel of 6 persons experienced in tasting savoury flavours is asked to evaluate the samples. The results are shown in table 3 below.

TABLE 3

| Sample | description |
|---|---|
| # 1 | balanced, vegetables recognizable, |
| # 2 | less reacted, balanced |
| # 3 | more reacted, less vegetable notes, taste more neutral |
| # 4 | too far reacted, onion notes stronger |
| # 5 | Less reacted, balanced |

### Results

The addition of sucrose (sample 2) reduces the colour value in comparison with no addition of sucrose (sample 1). The addition of sunflower oil or maltodextrin increased the colour value. Hence, sucrose can be used to improve the controllability of the reaction. Further, while the addition of oil or maltodextrin (sample 3 and 4, respectively) does not reduce the colour value, the addition in combination with salt and sucrose (sample 5) surprisingly provides a further improved controllability of the reaction in view of sucrose alone because it is less reacted. Further, samples 2 and 5 provide a balanced profile, meaning that flavours characteristic for a certain vegetable are less present. This improves the variety of applications in which the product can be used.

### Example 2

### Production Process Flavours Using Sucrose

Similar to example 1, process flavours were produced using the compositions according to samples 6 to 10 of table 4.

TABLE 4

| | % w/w based on total dry weight | | | | |
|---|---|---|---|---|---|
| | Sample | Sample | Sample | Sample | Sample |
| Component | 6 | 7 | 8 | 9 | 10 |
| Carrot, juice powder | 50.60 | 50.09 | 49.08 | 46.55 | 45.54 |
| Onion, powder | 32.42 | 32.10 | 31.45 | 29.83 | 29.18 |
| Celery leaves, grounded | 5.01 | 4.96 | 4.86 | 4.61 | 4.51 |
| Leek powder | 9.17 | 9.08 | 8.90 | 8.44 | 8.25 |
| Turmeric powder | 0.49 | 0.49 | 0.48 | 0.45 | 0.44 |
| Fat powder | 2.31 | 2.28 | 2.24 | 2.12 | 2.07 |
| Sucrose | 0.00 | 1.00 | 3.00 | 8.00 | 10.00 |

### Colour Measurement

Similar to example 1, the colour value is measured and is shown in table 5

TABLE 5

| Sample | # 6 | # 7 | # 8 | # 9 | # 10 |
|---|---|---|---|---|---|
| Colour value | 0.971 | 0.866 | 0.856 | 0.820 | 0.811 |

Additionally, the colour is measured according to Hunter L a b method as follows:

With a colour measurement spectrophotometer, the colour is measured according a standardized algorithm based upon “human view experience”. The result is defined as a fixed point in a three-dimensional space. The coordinates are expressed with the Hunterlab L-, a- and b-values. A fourth commonly used parameter is the yellowness index (Yi)-value.
L value: the amount of white saturation in a sample. A value of 100 is white, a value of 0 is black.
a value: the colour saturation green to red. A positive value is the red saturation, a negative value is the green saturation.
b value: the colour saturation yellow to blue. A positive value is the yellow saturation, a negative value is the blue saturation.
Yi value: the yellowness index, which is a mathematical calculation to represent the yellowness. The higher the value, the more yellow the sample.

The measurements are performed in “reflex mode”. The reflection of a sample is measured with a standardized illuminant (light source). Commonly this is known as the D65/10 source, which is intended to represent average midday daylight and has a correlated color temperature of approximately 6500 K and a light angle of 10°.

Apparatus: Hunterlab Ultrascan VIS Spectrocolorimeter, Micro port plate 9.525 mm with cuvette holder, Reflective shelf assembly with cover.

Conditions: all analyses are performed at ambient temperature in the following way:
Unscrew the cup of the micro cell cuvette holder.
Fill the cup with 200-300 mg of powder and screw the cup back on the holder.
Place the Teflon rod into the holder and compress the powder firmly with it.
Place the micro cell cuvette in the sample holder and measure the color.

The results are shown in table 6 below:

Colour measurements according to Hunter L a B

TABLE 6

| Sample | # 6 | # 7 | # 8 | # 9 | # 10 |
|---|---|---|---|---|---|
| L | 54.86 | 56.07 | 58.23 | 59.29 | 59.48 |
| a | 5.23 | 5.74 | 5.5 | 5.03 | 4.68 |
| b | 15.77 | 16.15 | 16.79 | 17.19 | 16.69 |
| YI | 60.04 | 60.64 | 60.11 | 59.73 | 59.48 |

### Sensory Analysis

TABLE 7

| Sample | description |
|---|---|
| # 6 | slight bitter, carrot, onion, celery, lingering |
| # 7 | weaker in taste, complex, less onion, celery, |
| | bland, lingering |
| # 8 | more blend, bit caramel, more flat, less peaky, |
| | bit musty, less reacted |
| # 9 | Less reacted, bit more celery, less intense, |
| | less onion, less lingering |
| # 10 | Less reacted, more celery, sweet, less intense, |
| | less onion, less lingering |

### Results

The addition of sucrose (sample 7, 8, 9 and 10) reduces the colour value in comparison with no addition of sucrose (sample 6). The addition of sunflower oil or maltodextrin increased the colour value (example 1). Hence, sucrose can be used to improve the controllability of the reaction.

### Example 3

### Production Process Flavours Using NaCl

To a lab scale twin-screw extruder, (equipped with a dosing unit), compositions according to samples 1 to 5 of table 8 were added and extruded with a throughput time of 2 minutes. The extruder was set at a temperature of 140° C., resulting in an incubation temperature of around 140° C. The products formed left the extruder in a room under atmospheric pressure and were cooled, and subsequently grinded and sampled.

TABLE 8

| | Sample | Sample | Sample | Sample | Sample |
|---|---|---|---|---|---|
| Component | 1 | 2 | 3 | 4 | 5 |
| Carrot, juice powder | 50.60 | 45.22 | 49.13 | 43.18 | 36.66 |
| Onion, powder | 32.42 | 28.97 | 31.48 | 27.67 | 23.49 |
| Celery leaves, grounded | 5.01 | 4.48 | 4.86 | 4.28 | 3.63 |
| Leek powder | 9.16 | 8.19 | 8.90 | 7.82 | 6.64 |
| Turmeric powder | 0.50 | 0.44 | 0.48 | 0.42 | 0.36 |
| Fat powder | 2.31 | 2.06 | 2.24 | 1.97 | 1.67 |
| NaCl | 0.00 | 10.63 | 0.00 | 0.00 | 12.45 |
| HOZOL | 0.00 | 0.00 | 2.91 | 0.00 | 4.31 |
| Maltodextrin IT12 P | 0.00 | 0.00 | 0.00 | 14.66 | 2.17 |
| Sucrose | 0.00 | 0.00 | 0.00 | 0.00 | 8.62 |

### Colour Measurement

1.00 gram of the samples 1 to 5 were weighted into a 250 ml plastic cup, and subsequently 100 ml of hot cooking water was added. The solutions were stirred twice for 10 seconds to homogenize. With a syringe 5 ml of the solutions was taken and filtrated over a Acrodisc 13 mm syringe filter with a 0.45 μm nylon membrane and the filtrate was measured in a disposable cuvette with dimension 12.5×12.5×45 mm The sample was measured at 400 nm and at a light pathlength of 12.5 mm, wherein water is used as reference. The colour value is shown in table 9.

TABLE 9

| Sample | # 1 | # 2 | # 3 | # 4 | # 5 |
|---|---|---|---|---|---|
| Colour value | 0.917 | 0.638 | 0.958 | 1.077 | 0.525 |

### Sensory Analysis

0.30 gram of the samples 1 to 5 were weighted into a 250 ml plastic cup, and subsequently 100 ml of hot cooking water was added. The solutions were stirred twice for 10 seconds to homogenize. The solutions were divided in tasting cups of 10 to 15 ml and a tasting panel of 6 persons experienced in tasting savoury flavours is asked to evaluate the samples. The results are shown in table 10 below.

TABLE 10

| Sample | description |
|---|---|
| # 1 | balanced, vegetables recognizable, |
| # 2 | less reacted, balanced |
| # 3 | more reacted, less vegetable notes, taste more neutral |
| # 4 | too far reacted, onion notes stronger |
| # 5 | Less reacted, balanced |

### Results

The addition of salt (sample 2) reduces the colour value in comparison with no addition of processing aids (sample 1). The addition of sunflower oil or maltodextrin increased the colour value. Hence, salt can be used to improve the controllability of the reaction. Further, while the addition of oil or maltodextrin (sample 3 and 4, respectively) does not reduce the colour value, the addition in combination with salt and sucrose (sample 5) surprisingly provides a further improved controllability of the reaction in view of salt alone.

### Example 4

### Production Process Flavours Using NaCl

Similar to example 3, process flavours were produced using the compositions according to samples 6 to 10 of table 11.

TABLE 11

| | % w/w based on total dry weight | | | | |
|---|---|---|---|---|---|
| | Sample | Sample | Sample | Sample | Sample |
| Component | 6 | 7 | 8 | 9 | 10 |
| Carrot, juice powder | 50.60 | 49.59 | 48.07 | 43.01 | 40.48 |
| Onion, powder | 32.42 | 31.77 | 30.80 | 27.56 | 25.94 |
| Celery leaves, grounded | 5.01 | 4.91 | 4.76 | 4.26 | 4.01 |
| Leek powder | 9.17 | 8.99 | 8.71 | 7.80 | 7.34 |
| Turmeric powder | 0.49 | 0.48 | 0.47 | 0.42 | 0.39 |
| Fat powder | 2.31 | 2.26 | 2.19 | 1.96 | 1.84 |
| NaCl | 0.00 | 2.00 | 5.00 | 15.00 | 20.00 |

### Colour Measurement

Similar to example 3, the colour value is measured and is shown in table 12

TABLE 12

| Sample | # 6 | # 7 | # 8 | # 9 | # 10 |
|---|---|---|---|---|---|
| Colour value | 0.971 | 0.698 | 0.655 | 0.557 | 0.593 |

Additionally, the colour is measured according to Hunter L a b method as follows:

With a colour measurement spectrophotometer, the colour is measured according a standardized algorithm based upon “human view experience”. The result is defined as a fixed point in a three-dimensional space. The coordinates are expressed with the Hunterlab L-, a- and b-values. A fourth commonly used parameter is the yellowness index (Yi)-value.
L value: the amount of white saturation in a sample. A value of 100 is white, a value of 0 is black.
a value: the colour saturation green to red. A positive value is the red saturation, a negative value is the green saturation.
b value: the colour saturation yellow to blue. A positive value is the yellow saturation, a negative value is the blue saturation.
Yi value: the yellowness index, which is a mathematical calculation to represent the yellowness. The higher the value, the more yellow the sample.

The measurements are performed in “reflex mode”. The reflection of a sample is measured with a standardized illuminant (light source). Commonly this is known as the D65/10 source, which is intended to represent average midday daylight and has a correlated color temperature of approximately 6500 K and a light angle of 10°.

Apparatus: Hunterlab Ultrascan VIS Spectrocolorimeter, Micro port plate 9.525 mm with cuvette holder, Reflective shelf assembly with cover.

Conditions: all analyses are performed at ambient temperature in the following way:
Unscrew the cup of the micro cell cuvette holder.
Fill the cup with 200-300 mg of powder and screw the cup back on the holder.
Place the Teflon rod into the holder and compress the powder firmly with it.
Place the micro cell cuvette in the sample holder and measure the colour.

The results are shown in table 13 below:

### Colour Measurements According to Hunter L a B

TABLE 13

| Sample | # 6 | # 7 | # 8 | # 9 | # 10 |
|---|---|---|---|---|---|
| L | 54.86 | 58.44 | 59.76 | 60.96 | 61.61 |
| a | 5.23 | 4.61 | 3.90 | 4.20 | 3.79 |
| b | 15.77 | 16.72 | 16.11 | 16.81 | 16.30 |
| YI | 60.04 | 58.60 | 54.54 | 55.97 | 61.61 |

### Sensory Analysis

TABLE 14

| Sample | description |
|---|---|
| # 6 | slight bitter, carrot, onion, celery, lingering |
| # 7 | bit less reacted, carrot, onion, less strong, vegetable, lingering |
| # 8 | less reacted, sweet, carrot, onion, bit metallic, lingering |
| # 9 | Less reacted, more celery, sweet, carrot, less lingering, less |
| | peaky, more round |
| # 10 | Less reacted, carrot, weaker, onion, rounder, less lingering |

### Results

The addition of NaCl (sample 7, 8, 9 and 10) reduces the colour value in comparison with no addition of NaCl (sample 6). The addition of sunflower oil or maltodextrin increased the colour value (example 3). Hence, salt can be used to improve the controllability of the reaction.

1. Method for producing a process flavour comprising:
a) preparing a composition comprising a vegetable and a processing aid chosen from sucrose, NaCl and KCl or combinations thereof, optionally sucrose and/or NaCl;
b) intimately mixing the composition in an extruder under conditions of temperature and reaction time sufficient for the process flavour to develop;
wherein the composition does not comprise yeast, yeast extract or yeast autolysate;
wherein the amount of vegetable is within a range of 50 to 98% (w/w) of the composition;
wherein the water content of the composition before or during b) is between 1% and 8% w/w based on the total weight of the composition.

2. The Method according to claim 1, wherein the amount of processing aid is within a range of 0.01 to 40% (w/w) of the composition.

3. The Method according to claim 1, wherein the processing aid comprises sucrose and NaCl.

4. The Method according to claim 1, wherein the composition further comprises maltodextrin and/or oil.

5. The Method according to claim 1, wherein the vegetable is in the form of a powder.

6. The Method according to claim 1, wherein the vegetable is chosen from the group consisting of soy, onion, garlic, cabbage, carrot, celery, mushroom, tomato, bell pepper, leek, scallion, shallot, corn, rice, cauliflower, asparagus and broccoli.

7. The Method according to claim 1, wherein the developed process flavour has a L value of larger than 55 on a Hunter LAB colour scale, optionally wherein the L value is measured according to the following test:
using a Hunterlab Ultrascan VIS Spectrocolorimeter, having a Micro port plate 9.525 mm with cuvette holder with a reflective shelf assembly with cover; using the following at ambient temperature:
unscrew the cup of the cuvette holder;
fill the cup with 200-300 mg of the process flavour and screw the cup back on the cuvette holder;
optionally, place a teflon rod into the cup and compress the powder firmly with it;
place the cuvette holder in the sample holder and measure the colour.

8. The Method according to claim 1, wherein the temperature of b) is between 100° C. and 160° C., optionally between 110° C. and 150° C.

9. The Method according to claim 1, wherein reaction time is within the range of 3 seconds to 6 minutes.

10. Process flavour obtainable by the method according to claim 1.

11. Process flavour comprising vegetable and sucrose, NaCl and/or KCl, optionally wherein the vegetable and sucrose, NaCl and/or KCl are homogenously distributed in the process flavour.

12. The Process flavour according to claim 10, having a colour value within a range of 0.01 to 3.2 measured at 400 nm and at a light pathlength of 12.5 mm if dosed at 1 gram in 100 ml hot cooked water.

13. The Process flavour according to claim 12, wherein the colour value is measured according to the following test: 1.00 gram of the process flavour is weighted into a 250 ml plastic cup, and subsequently 100 ml of hot cooking water is added; the solutions is stirred twice for 10 seconds to homogenize; with a syringe 5 ml of the solution is taken and filtrated over a Acrodisc 13 mm syringe filter with a 0.45 μm nylon membrane and the filtrate is measured in a disposable cuvette with dimension 12.5×12.5×45 mm; the process flavour is measured at 400 nm and at a light pathlength of 12.5 mm, wherein water is used as reference.

14. The Process flavour according to claim 10, wherein the process flavour has a L value of larger than 55 on a Hunter LAB colour scale, optionally wherein the L value is measured according to the following test:
using a Hunterlab Ultrascan VIS Spectrocolorimeter, having a Micro port plate 9.525 mm with cuvette holder with a reflective shelf assembly with cover; using the following at ambient temperature:
unscrew the cup of the cuvette holder;
fill the cup with 200-300 mg of the process flavour and screw the cup back on the cuvette holder;
optionally, place a teflon rod into the cup and compress the powder firmly with it;
place the cuvette holder in the sample holder and measure the colour.

15. A product comprising the process flavour as defined in claim 10 in preparing food or feed.
